(19) United States
(12) Patent Application Publication
(10) Pub. No.: US 2026/0274144 A1
(43) Pub. Date: Sep. 17, 2026

(54) TRANSPORT SYSTEM AND METHOD FOR FLAT-BOTTOMED CONTAINERS

(71) Applicant: Clean City Cargo Concept ApS, Ringsted (DK)

(72) Inventor: Per Lavmand, Espergærde (DK)

(73) Assignee: Clean City Cargo Concept ApS, Ringsted (DK)

(21) Appl. No.: 19/472,350

(22) PCT Filed: Apr. 4, 2024
(86) PCT No.: PCT/DK2024/050082

§ 371 Date: Oct. 3, 2025

(30) Foreign Application Priority Data
Apr. 5, 2023 (DK) 202370171
Apr. 5, 2023 (DK) 202430040

(51) Int. Cl. B60P 1/64; B65D 88/12; B65D 90/18

(52) U.S. Cl. CPC B60P 1/6454; B65D 88/12; B65D 90/18

(57) ABSTRACT

Trailer, container, transport system and method for handling a container. The trailer (1) has a frame structure (11) pivotally connected to a drawbar (21) and at least two substantially parallel elongated guides (12) for guiding linear movement of a flat-bottomed container (3) along the frame structure (11) through corresponding front rollers (30) and/or guide rails (31) arranged on the bottom of the container (3) when being pulled by a winch (17) arranged on a towing end (40) of the trailer (1) or when being pushed in a direction away from the winch (17) by a resilient pushing device (14) arranged on the frame structure (11).

### TECHNICAL FIELD

The present invention relates generally to transport systems for containers and more specifically to single or dual axle trailers for transporting flat-bottomed cargo containers, the trailers being towable by trucks, lorries, or other vehicles. The invention furthermore relates to a system comprising such trailers and corresponding cargo containers, as well as methods for handling such trailers for loading and transporting corresponding containers for distributing cargo in an environmentally friendly manner, for instance within a city.

### BACKGROUND

The field of cargo transport faces a number of challenges.

In known and existing distribution transfer systems the goods are collected in the country and outside of the country and transported over individual routes. All transport has to go through the outer zones of the city. This results in a lot of traffic with traditional combustion engine driven heavy vehicles such as lorries and trucks in the peripheral zone of the city leading to dense-traffic situations, high emission levels and noise levels. In addition, delivery of goods in the inner zones of a city also takes place with larger vehicles, which vehicles may not be particularly friendly to the environment.

On the other hand, many smaller and more environmentally friendly vehicles nowadays (such as hybrid or electric passenger vehicles and transport vans) are able to tow lighter cargo trailers that can be used for transporting containers to a certain weight limit. For example, the average braked towing capacity of electric vehicles is around 1, 400 kg and can range from 300 kg to 2,500kg.

Cargo containers are generally metallic structures vastly used to transport items or materials over land via roadways or railways or via sea transportation. They can be of various sizes depending on their purpose and cargo to be transported or the means of transport vehicles used, such as intermodal containers, freight containers, ISO containers, shipping containers, or hi-cube containers. In civilian applications, cargo containers may be used to transport a variety of different types of equipment or materials, or even construction waste. Cargo containers can also be used to temporarily or permanently store objects. Loading and unloading of such cargo containers onto trucks or other means of transportation or storage can be carried out by various means. For instance, vertically lifting cranes can be used to load and unload heavy containers, and smaller industrial vehicles equipped with forklifts can be used to load and unload lighter containers.

Smaller or lighter weight containers can be loaded and unloaded onto vehicle trailers without use of a crane or forklift. For this purpose, vehicle trailer systems are known in the art comprising a tiltable trailer bed and a winch capable of dragging the container onto the trailer bed. For this a front side of the container is usually initially lifted from the ground by using e.g. a jack stand and the loading end of the trailer is pushed underneath the container front end. The container is then dragged onto a tilted trailer bed which is coupled to a towing vehicle. After the container is loaded, the trailer is tilted to a generally horizontal transport position for transport of the container to the desired destination.

US20070003398A1 describes such a container trailer with a frame having a rear end and a forward end pivotally connected to it. The frame has a pair of spaced axles having dual wheels, as well as a winch assembly. A hydraulic cylinder is pivotally mounted between frame portions to move the frame from a horizontal to tilted position. In the tilted position, a container that is located at ground level can be loaded onto the frame. A forward portion of the container engages the rear end of the frame and is hoisted on the trailer using the winch assembly, which can be electrically or manually operated. The containers have castors that are designed to help the container roll on the ground and to be guided onto 2 or more parallel channels on the trailer.

U.S. Pat. No. 4,930,799A describes a similar vehicle trailer system which includes a trailer, a pivotable structure coupled to the trailer, a longitudinal guide along which a container is displaceable, and a locking device for securing the container to the pivotable frame element. The trailer further has a winch by means of which the basic frame can be hauled up on the inclined frame element. Further described in this prior art document are different alternatives for a flat-bottomed container that corresponds to the trailer with guide rails for guiding the containers on and off the trailer when pulled by the winch. The containers have rollers arranged in the back.

EP3098112A1 describes another solution loading and unloading an interchangeable platform onto a transport vehicle. The interchangeable platform is loaded and unloaded from the transport vehicle using a carrier arranged slidably on a frame structure of the transport vehicle and pulled by a loading reel rotated in a loading or unloading direction.

US20200198886A1 describes transportable container, wherein the container comprises two sidewalls; a front wall; and a floor; and a mating assembly, wherein the mating assembly is attached to the container and comprises two or more rails secured to an underneath plane of the floor. Front rollers can be positioned between the front ends of the rails for enabling the rails to engage with hoist rails of the roll-off truck. In this prior art system rollers are arranged on the outsides of the hoist rails supported on an arbor to engage with the rails of the subfloor of the container.

US20200346850A1 describes a similar container system, wherein a substructure of the container comprises a pair of longitudinal rails which extend along the length thereof and for providing support for its bottom wall and facilitate loading, unloading, and transport of container on a hoist frame, with elevated front rollers arranged between the longitudinal rails, as well as further rollers arranged on the bottom of the container for rolling on the ground.

US20150298901A1 also describes a container with longitudinal rails extending along its bottom, wherein a pair of front wheels are arranged to be movable between the front part of the longitudinal rails from a raised to a lowered position so that the weight of the container can rest on the front wheels and on rear wheels when the container is not hoisted by a lifting device.

A common disadvantage of these trailer transport systems is that they require use of hydraulics or other means installed on the trailer for the initial tilting of the trailer bed, and even more so for tilting the trailed bed for unloading the container from the trailer after arriving to the final destination. This considerably increases weight of the trailers which in turn reduces the usable range of vehicles for towing such trailers. The use of hydraulics or other means installed on the trailer also requires specialized knowledge and training, which most drivers of passenger vehicles or other transport vans may not possess.

On the other hand, during loading, friction between the container and the trailer may be considerable. Thus, power required to carry out the loading process may be high, which usually requires additional power in the form of electric motors for the winch or presence of additional human operators for the loading and unloading of containers.

In addition, misalignments between the container and the trailer bed may greatly hinder loading of the container, as alignment cannot be corrected due to the elevated friction between the trailer bed and the container. This is an important drawback, as in practice it can be very difficult to achieve an optimum longitudinal alignment between the trailer and the container prior to loading.

Furthermore, when loading and unloading containers to a trailer vehicle, there is a high risk of tipping over of the container to either side if the center of gravity is not aligned with the center of the trailer. This risk is especially high if the cargo inside the container is not evenly distributed, resulting in different loads on the guide rails during loading and unloading.

Accordingly, there is an established need for transport system which is lightweight so it can be used with passenger vehicles and small to medium sized transport vans, and in the same time suitable for loading, transporting and unloading a cargo container in a simple manner without risk of tipping over, in a way that is easily operable by a single user without the need of electricity, hydraulics or other power source, additional vehicles, or additional human operators. It would further be desirable to provide such transportation means that are friendly to the environment and which can take care of transport of cargo for instance in the inner regions of a city.

### SUMMARY

On this background, it is an object of the invention to provide transport means that allow environmentally friendly transport of cargo. This object is according to the invention solved by the provision of trailers and containers or swap boxes that are provided with means for easy and effective loading and unloading on/from such trailers. To this effect, the trailers of the present invention are also provided with means for releasable attachment to a transport vehicle, preferably a vehicle of a kind that is particularly friendly to the environment. Such vehicles could for instance be battery-powered distribution vehicles. The advantages of such vehicles are low emission, low noise level, and good battery longevity for short distance distribution. A further advantage of small vehicles is that they are more maneuverable in the city, and are better for traffic safety.

The foregoing and other objects are achieved by the features of the independent claims. Further implementation forms are apparent from the dependent claims, the description and the figures.

It is noted that although the specific term “container” is used throughout this specification, sometimes together with the alternative term “swap box”, a “container” should be interpreted broadly to comprise any means that can accommodate goods or other cargo to be transported and/or stored. Thus, for instance, an upwardly open box of wood or any other material will also fall within the scope of the term “container” as used in this specification.

According to a first aspect, there is provided a single or dual axle trailer for transporting a container, the trailer comprising a towing end and an oppositely arranged loading end; a drawbar arranged at the towing end and configured to be attached to a towing vehicle; and a frame structure pivotally connected to the drawbar for selectively allowing the frame structure to pivot about a pivot axis parallel with the single or dual axle; the frame structure comprising at least two substantially parallel elongated guides for guiding linear movement of the container along the frame structure; a winch for pulling the container from the loading end in a direction towards the winch; and a pushing device configured to push the container in a direction away from the winch, wherein the pushing device comprises a bracket arranged slidably on the frame structure and at least one resilient element configured to urge the bracket away from the winch.

Using such a trailer with parallel elongated guides for guiding linear movement of the container and a combination of a winch to pull the container from the loading end as well as a pushing device with a bracket and a resilient element configured to push the container in a direction away from the winch results in a lightweight trailer that can be operated by a single operator both for loading and offloading containers on the trailer.

Since the pushing device can be a simple resilient element, the trailer can be operated without the need of electricity, hydraulics or other power source that would make the trailer bulky and would require specialized knowledge.

In an embodiment the trailer is a single axle trailer. In another embodiment the trailer is a dual axle trailer.

In a possible implementation form of the first aspect the guides comprise elongated channels configured for slidably guiding the container along the frame structure.

In an embodiment the elongated channels have a substantially L-shaped cross-section with a horizontal support wall and a vertical guide wall for restricting lateral movement of the container in a direction outward from the center of the trailer.

In an embodiment the elongated channels comprise an upwardly and outwardly slanted guide wing for guiding corresponding parts of the bottom of the container into the channels.

In an embodiment the elongated channels comprise an elongated channel rail arranged therein for providing vertical support for the weight of the container and for restricting upward movement of the container via an elongated lateral channel rail recess arranged therein.

In an alternative embodiment the guides comprise a plurality of guide rollers arranged within the elongated channels along a length of the guides.

In an embodiment the bracket comprises an aperture for allowing a winch cable of the winch to pass through for connecting to a hoist attachment arrangement on a container.

In an embodiment the bracket comprises a bracket roller for movably engaging the container.

In a possible implementation form of the first aspect the frame structure comprises a crossbar with a pair of wheels arranged at its distal ends, the crossbar being arranged perpendicular to the guides; and a middle bar arranged between and parallel to the guides, the middle bar being pivotally connected to the drawbar and non-pivotally connected to the crossbar and extending to the loading end of the trailer, wherein the bracket is arranged on the middle bar.

In a possible implementation form of the first aspect the bracket is connected to the middle bar through the at least one resilient element configured to urge the bracket away from the winch until a position at the distal end of the middle bar.

In an embodiment the at least one resilient element is a gas spring configured to exert a resilient force on the bracket via a dampened extending and retracting motion.

In an embodiment the at least one resilient element is arranged within the middle bar and configured to urge the bracket away from the winch, wherein the bracket is connected to the at least one resilient element via a pulley system.

In an embodiment the middle bar comprises a rotatable end element arranged at the loading end for supporting a license plate, wherein the rotatable end element is configured for automatically rotating when engaging with the ground.

In an embodiment the rotatable end element comprises rollers for movably engaging the ground.

In an embodiment the frame structure comprises a handle arranged to manually engage and tilt the frame structure.

In an embodiment the frame structure comprises end rollers arranged adjacently to the elongated guides to engage with the ground when the frame structure is tilted and for taking over the bearing of the container when the container back rollers arranged on the bottom of the container leave the ground by providing an engagement and guiding surface for guide rails arranged on the bottom of the container, thereby facilitating loading the container on the frame structure.

In an embodiment the elongated guides comprise rotatable side elements for supporting brake lights of the trailer, wherein the rotatable side elements are configured for automatically rotating around a side element axis when the frame structure engages with the ground so that the brake lights don't interfere with the loading of the container on the trailer.

In an embodiment the crossbar defines a wheel axis around which the frame structure is arranged to tilt; wherein the pivot axis is arranged off-axis from the wheel axis towards the winch.

In a possible implementation form of the first aspect the trailer further comprises a tilt lock connected to both the frame structure and the drawbar and configured to hold the frame structure at a tilted position by keeping a minimum distance between its two contact points to the frame structure and the drawbar respectively.

In an embodiment the tilt lock comprises an elongated tilt lock slot, wherein the tilt lock is configured to be connected to the frame structure via a tilt lock pin arranged to slidably move in the tilt lock slot to allow limited tilting movement of the frame structure while still keeping a minimum distance from the drawbar.

This mechanism allows the operator of the trailer 1 to easily assess visually (and also audibly) at all times where the weight center of the container 3 is with respect to the trailer 1 which helps indicating at which point it is easiest to tilt the frame structure 11 around the pivot axis 20 using e.g. a handle 39 supported on the frame structure 11.

In an embodiment the trailer comprises a tilt control device arranged between the frame structure and the drawbar and configured to dampen the tilting movement of the frame structure around the pivot axis.

In an embodiment the tilt control device is a gas spring.

In a possible implementation form of the first aspect the frame structure further comprises a frontal locking arrangement arranged at a towing end of the trailer to releasably hold a container in a fixed position on the trailer.

In an embodiment the frontal locking arrangement comprises a safety mechanism, such as a latch, that locks automatically when engaging with a corresponding part of the container and disengages manually or automatically when the container is pushed away from the trailer. This mechanism enhances safety in case the operator would forget locking the container on the trailer.

In an embodiment the frontal locking arrangement is configured for allowing the container to slide in a direction away from the winch.

In an embodiment each of the at least two guides comprises a frontal locking arrangement arranged on their distal end towards the winch and configured to engage correspondingly arranged frontal reinforcements on a side wall of a container.

In an embodiment the frontal locking arrangement comprises an elongated protruding element configured to be received in a correspondingly sized frontal locking hole arranged in the frontal reinforcements.

In an embodiment the frontal locking arrangement comprises a stop bracket configured for restricting movement of the trailer in a direction towards the winch.

In an embodiment the frontal locking arrangement is arranged to be slidable along the elongated guide and lockable in various positions along the length of the guide.

In an embodiment the frontal locking arrangement is lockable in position using a removable locking pin configured to engage correspondingly sized holes in the guide.

In a possible implementation form of the first aspect at least one of the guides comprises a lateral locking arrangement configured to releasably hold the container in a fixed position on the frame structure, the lateral locking arrangement being positioned on the at least one guide at its loading end.

In an embodiment the lateral locking arrangement is configured to engage with correspondingly arranged lateral engagement holes on the container.

In an embodiment each guide comprises a frontal locking arrangement arranged at the towing end, and a lateral locking arrangement arranged at the loading end.

According to a second aspect, there is provided a container comprising a substantially flat rectangular bottom and side walls together defining an at least partially enclosed space above the bottom for accommodating cargo; the container comprising at least two parallel guide rails arranged under the flat bottom, the guide rails being arranged substantially parallel to a second and fourth edge of the bottom and extending from a first edge of the bottom towards a third edge of the bottom, wherein the guide rails comprise a planar bottom surface that curves or angles upwards at the first edge thereby defining a contact surface for slidably guiding the container onto a transport vehicle such as a trailer.

The container further comprises container front rollers arranged at the first edge adjacent to the guide rails on an outer side thereof towards respective second and fourth edges of the flat bottom in a lifted position off the ground when the container is resting on the ground.

The combination of parallel guide rails with upwardly curving or angling contact surface, and front rollers arranged in a lifted position ensures a precise and smooth engagement with correspondingly arranged guides of a transport vehicle which enables efficient loading and offloading of such containers to transport vehicles.

Arranging front rollers on the outer side of parallel guide rails under the container further lowers the risk of tipping compared to prior art systems, enabling a linear guiding engagement between the outer side of the container guide rails and the guides of the transport vehicle, while the front rollers can roll on the guides of the transport vehicle. This engagement ensures the center of gravity of the container being aligned with the center of the transport vehicle.

In an embodiment, the contact surface is configured for sliding over guide means of a trailer, such as an edge of an elongated guide or rollers arranged at a corresponding distance on trailer for facilitating loading the container on the trailer.

In an embodiment the container comprises at least one pair of container front rollers arranged to correspond to at least two elongated guides of a trailer for guiding linear movement of the container along a frame structure of the trailer when pulled by a winch or when pushed by a pushing device.

In an embodiment the front rollers are arranged to be vertically movable, so that they can provide rolling function on the ground but can also be lifted up when the container is loaded onto a transport vehicle and provide rolling function with corresponding elements of the transport vehicle.

In a possible implementation form of the second aspect, the bottom surface curves upwards at the first edge thereby defining a rounded contact surface.

In another possible implementation form of the second aspect the bottom surface is angled upwards at the first edge thereby defining a chamfered or beveled contact surface.

In an embodiment the contact surface is inclined at a contact angle, the contact angle preferably being between 30 to 60 degrees, more preferably 45 degrees with respect to the bottom surface.

In another embodiment the contact surface comprises a stepped inclination at different consecutive angles.

In a possible implementation form of the second aspect the container further comprises at least one container back roller arranged on the bottom at an opposite distal end of the container from the at least one container front roller for engagement between the container and the ground and facilitating linear movement of the container on the ground.

In an embodiment the container further comprises a hoist attachment arrangement for attaching a winch cable of a winch.

In a possible implementation form of the second aspect at least one of the elongated guide rails comprises lateral engagement holes configured to engage with a lateral locking arrangement of a trailer.

In a possible implementation form of the second aspect the container further comprises at least two parallel frontal reinforcements on at least one side wall configured to provide additional structural support for the container, the frontal reinforcement being arranged as a vertical continuation of the horizontal guide rails.

In an embodiment the frontal reinforcements are arranged on a same side wall as the at least two container front rollers, the container front rollers being arranged adjacent to the frontal reinforcements.

In an embodiment the frontal reinforcements comprise engaging elements for engagement with corresponding frontal locking arrangement of the trailer to releasably hold the container in a fixed position on the trailer.

In an embodiment each frontal reinforcement comprises a frontal locking hole arranged to receive an elongated protruding element of a corresponding frontal locking arrangement of the trailer.

According to a third aspect, there is provided a transport system comprising a trailer according to a possible implementation form of the first aspect and a container comprising a substantially flat rectangular bottom; the container comprising at least one of parallel guide rails or container front rollers arranged under the flat bottom correspondingly to at least two elongated guides of the trailer for guiding linear movement of the container along the frame structure when pulled by the winch or when pushed by the pushing device.

In possible embodiments the container further comprises side walls defining an at least partially enclosed space above the bottom for accommodating cargo.

In possible embodiments the guide rails comprise a planar bottom surface that curves or angles upwards at the first edge thereby defining a contact surface for slidably guiding the container onto a transport vehicle such as a trailer.

In possible embodiments the contact surface is configured for sliding over guide means of the trailer, such as an edge of an elongated guide or rollers arranged at a corresponding distance on the trailer for facilitating loading the container on the trailer.

In possible embodiments the container further comprises container front rollers arranged adjacent to the guide rails on an outer side thereof in a lifted position off the ground when the container is resting on the ground.

In a possible implementation form of the third aspect, at least two elongated guide rails of the container are arranged correspondingly to at least two elongated guides of the frame structure of the trailer for guiding linear movement of the container along the frame structure when pulled by the winch or when pushed by the pushing device. In a possible implementation form of the third aspect, at least two container front rollers of the container are arranged correspondingly to at least two elongated guides of the frame structure of the trailer for rolling movement of the container along the frame structure when pulled by the winch or when pushed by the pushing device.

In a possible implementation form of the third aspect, the container is a container according to a possible implementation form of the second aspect.

According to a fourth aspect, there is provided a method of handling a container comprising the steps of: providing a trailer according to a possible implementation form of the first aspect;
providing a container comprising a substantially flat rectangular bottom, and at least one of parallel guide rails or container front rollers arranged under the bottom correspondingly to the at least two elongated guides of the trailer;
pulling the container in a first direction onto the frame structure using the winch while engaging at least one of the guide rails or the container front rollers with the elongated guides; and
securing the container on the frame structure using at least one releasable locking arrangement.

In a possible implementation form of the fourth aspect the method further comprises the steps of:
before pulling the container onto the frame structure, tilting the frame structure around a pivot axis from a horizontal position to a tilted position;
fixing the frame structure in a tilted position using a tilt lock connected to both the frame structure and the drawbar; and
moving the container from a first position where the container is at least partially resting on the ground and where the frame structure is engaged with the ground into a second position where the frame structure is still at least partially resting on the ground but the container is no longer engaged with the ground.

In a possible implementation form of the fourth aspect the method further comprises the steps of:
when the container is in the second position, unlocking the tilt lock and tilting the frame structure around the pivot axis from the tilted position to the horizontal position; and
further moving the container into a third position where the container can be secured on the trailer.

In a possible implementation form of the fourth aspect the method further comprises the steps of:
before pulling the container onto the frame structure, securing a winch cable of the winch of the trailer at one end to a hoist attachment arrangement arranged on the container; and activating a winch drum of the winch to actuate moving the container in a first direction onto the frame structure; and
once the container is in the third position, fully locking the winch drum and securing the container on the frame structure using at least one of a frontal locking arrangement, and a lateral locking arrangement.

In a possible implementation form of the fourth aspect the method further comprises the steps of:
activating the pushing device to exert a force on the container and push the container away from the winch in a second direction; and
moving the container along the guides using the pulling force of the winch and the pushing force of the pushing device until at least a portion of the container engages with the ground in a tilted position of the frame structure.

In a possible implementation form of the fourth aspect the method further comprises the step of moving either the trailer or the container relative to each other until the container is entirely off from the frame structure.

In a possible implementation form of the fourth aspect the container is a container according to a possible implementation form of the second aspect.

According to a fifth aspect, there is provided a method of handling a container comprising the steps of:
providing a trailer according to a possible implementation form of the first aspect;
providing a container on the trailer, the container comprising a substantially flat rectangular bottom, side walls, and at least one of parallel guide rails or container front rollers on the bottom arranged on corresponding elongated guides of the frame trailer, the winch being connected to the container and the pushing device engaging one of the side walls;
activating the at least one resilient element of the pushing device to urge the bracket away from the winch and thereby exert a force on the container and push the container away from the winch in a second direction; and moving the container along the guides using the pulling force of the winch and the pushing force of the pushing device until at least a portion of the container engages with the ground in a tilted position of the frame structure.

In a possible implementation form of the fifth aspect, the method further comprises the step of moving either the trailer or the container relative to each other until the container is entirely off from the frame structure.

In a possible implementation form of the fifth aspect, the method further comprises the steps of:
before the container engages with the ground, tilting the frame structure around a pivot axis from a horizontal position to a tilted position;
fixing the frame structure in the tilted position using a tilt lock connected to both the frame structure and the drawbar; and
after the container is entirely off from the frame structure, unlocking the tilt lock to allow the frame structure to move from the tilted position back to the horizontal position.

In a possible implementation form of the fifth aspect, the method further comprises the steps of:
before activating the pushing device, securing a winch cable of the winch of the trailer at one end to a hoist attachment arrangement on the container; and
unlocking a winch drum of the winch to allow linear movement of the container controllably along the frame structure.

In a possible implementation form of the fifth aspect the container is a container according to a possible implementation form of the second aspect.

Further objects, features, advantages and properties of the platform system according to the disclosure will become apparent from the detailed description.

### BRIEF DESCRIPTION OF THE DRAWINGS

In the following detailed portion of the description, the invention will be explained in more detail with reference to the exemplary embodiments shown in the drawings, in which:

FIG. 1 is a side view of a trailer according to an example embodiment of the invention;

FIG. 2 is a top view of a trailer according to an example embodiment of the invention;

FIG. 3 is an isometric view of a trailer according to an example of the invention;

FIG. 4 is a side view of a trailer and a container according to an example of the invention arranged adjacently in a state before loading the container on the trailer;

FIG. 5 is a side view of a trailer and a container according to an example of the invention in a state during loading the container on the trailer;

FIG. 6 is an isometric view of a trailer and a container according to an example of the invention in a state during loading the container on the trailer, with a zoomed-in view of the details of the guide rails of the container;

FIG. 7 is a partial zoomed-in isometric view of a trailer and a container according to an example of the invention arranged in a state during loading the container on the trailer;

FIG. 8 is a partial zoomed-in side view of a trailer and a container according to an example of the invention in a state during loading the container on the trailer;

FIG. 9 is a partial zoomed-in angled back view of a trailer and a container according to an example of the invention in a state during loading the container on the trailer;

FIGS. 10 through 12 illustrate side views of a trailer and a container according to an example of the invention in consecutive states during loading the container on the trailer;

FIGS. 13 and 14 illustrate isometric views of a trailer and a container according to an example of the invention in consecutive states during loading the container on the trailer with zoomed-in view of the different states of the tilt lock mechanism;

FIG. 15 shows a cross-section of the longitudinal beam of a guide of the trailer according to an example of the invention;

FIG. 16 shows a partial zoomed-in top view of a trailer and a container according to an example of the invention when the container is loaded on the trailer in an almost final transport position ;

FIG. 17 shows a partial zoomed-in perspective view of the frontal locking arrangement of a trailer according to an example of the invention;

FIG. 18 shows a partial zoomed-in perspective view of the back of trailer and a container according to an example of the invention arranged in a transport state;

FIG. 19 shows a partial zoomed-in perspective view of the front of trailer and a container according to an example of the invention arranged in a transport state;

FIGS. 20 and 21 illustrate perspective views of rotatable end element and side elements arranged on the back of a trailer according to an example of the invention; and

FIGS. 22 through 24 illustrate different views of a pushing device arranged on the trailer according to an example of the invention.

### DETAILED DESCRIPTION

In the following a detailed description example embodiments of attachment structures, containers, support structures and transport vehicles according to the invention are given, but it is understood that these embodiments only constitute non-limiting examples of how the present invention can be implemented in practice.

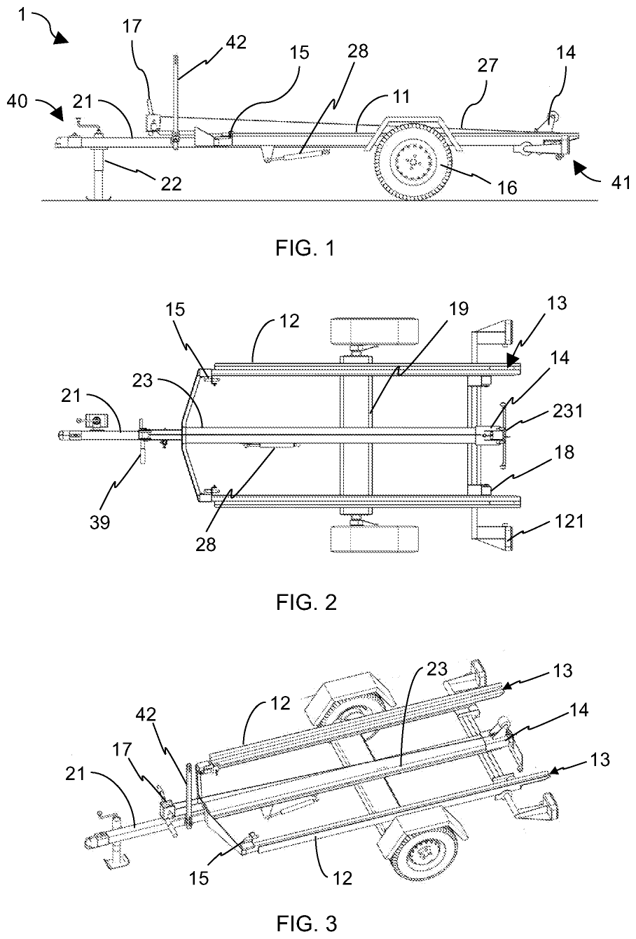

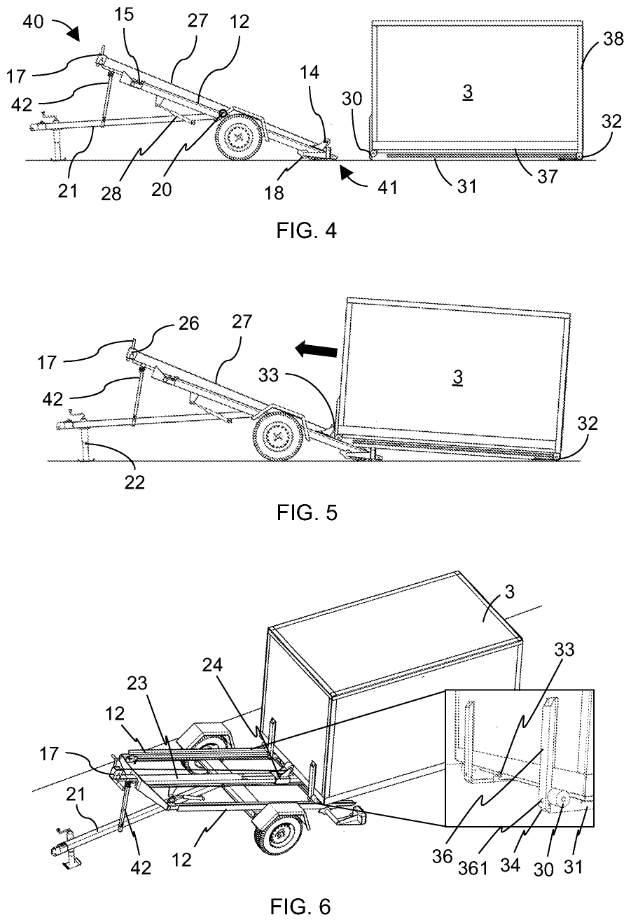

With reference to FIG. 1 there is shown a schematic side view representation of a trailer 1 according to a first example embodiment of the invention. The trailer is generally indicated by reference numeral 1 and comprises a towing end 40 connectable to a towing vehicle via commonly known towing connection means, and an oppositely arranged loading end 41 for loading a container 3 onto the trailer 1. In particular, a drawbar 21 is arranged at the towing end 40 and configured to be attached to a towing vehicle via such towing connection means. The drawbar 21 is supported by a jack stand 22 or any suitable means for holding the drawbar 21 at a certain position and distance with respect to the ground when the drawbar 21 is not attached to a towing vehicle. A frame structure 11 is pivotally connected to the drawbar 21 for selectively allowing the frame structure 11 that serve as the trailer bed to pivot about a pivot axis 20 (shown in FIG. 4) parallel with the single or dual axle.

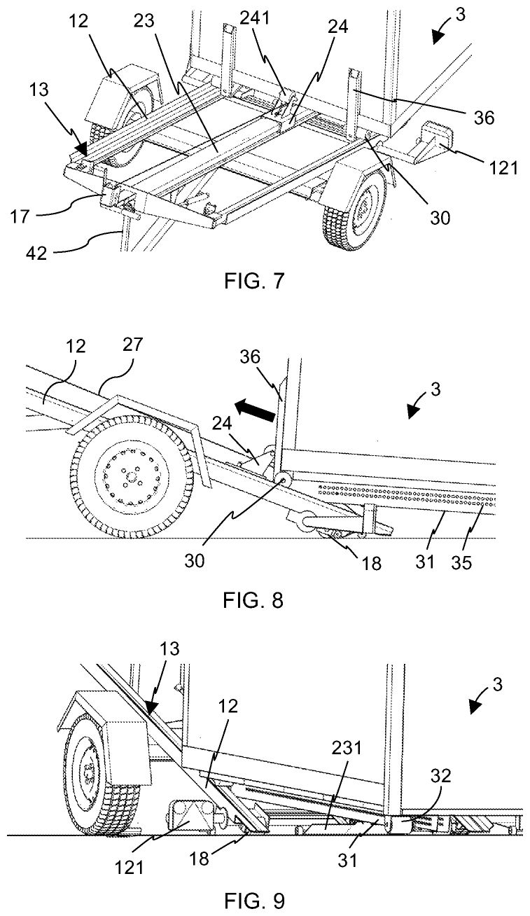

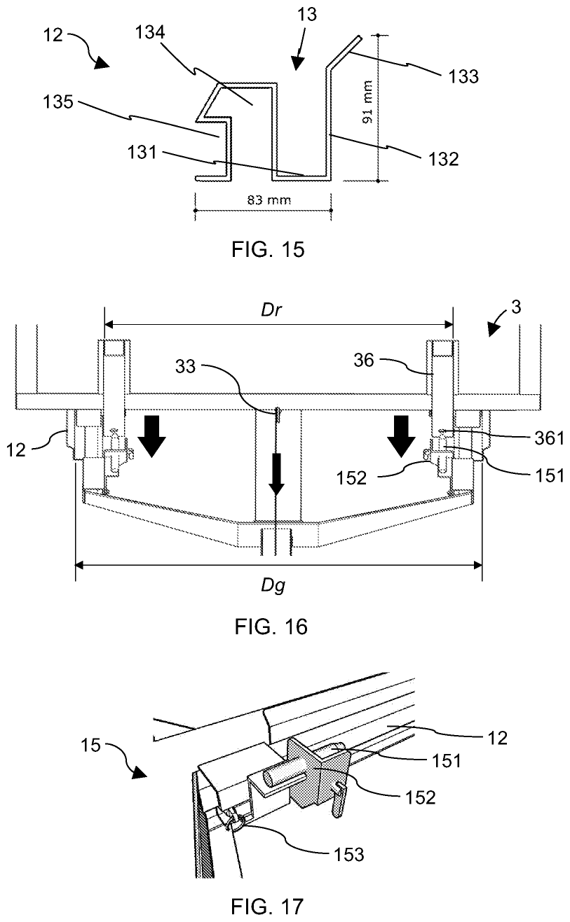

The frame structure 11 comprises at least two substantially parallel elongated guides 12 for guiding a container 3 along the frame structure 11 in a linear movement. The guides 12 may comprise elongated channels 13 configured for slidably guiding the container 3 along the frame structure 11 via correspondingly arranged and dimensioned rails or rollers, as illustrated in more detail in FIGS. 7 and 9). Alternatively, other configurations can also be envisioned that are suitable for slidably guiding containers 3 along the frame structure 11, such as rollers arranged on the guides 12 or arranged within the elongated channels along a length of the guides 12, so that the rollers can guide corresponding beams or rails arranged on containers 3. The elongated channels are further described in relation to FIG. 15 which show a cross-section of the beams of the guides 12.

The trailer 1 further comprises a winch 17 for pulling the container 3 from the loading end 41 in a direction towards the winch 17. In particular, the winch 17 is configured to pull the container 3 from a first position where the container is at least partially resting on the ground and where the container 3 is not or partially supported by the trailer 1 (as shown in FIGS. 5, 10 and 11) towards a second position where the container 3 is fully supported by the trailer 1 (as shown in FIG. 12).

The winch comprises a winch drum 26 that can be rotated through a handle, and which drives a winch cable 27 that can be attached at its distal end to a hoist attachment arrangement 33 on a container 3 as shown in FIG. 16 for example to pull the container 3 along the guides 12 on the trailer 1.

A pushing device 14 is further arranged on the trailer 1 to push the container 3 in a direction away from the winch 17. This pushing device can be arranged in the form of a bracket 24 arranged slidably on the frame structure 11 and configured to engage and push the container 3 away from the winch 17 along the frame structure 11.

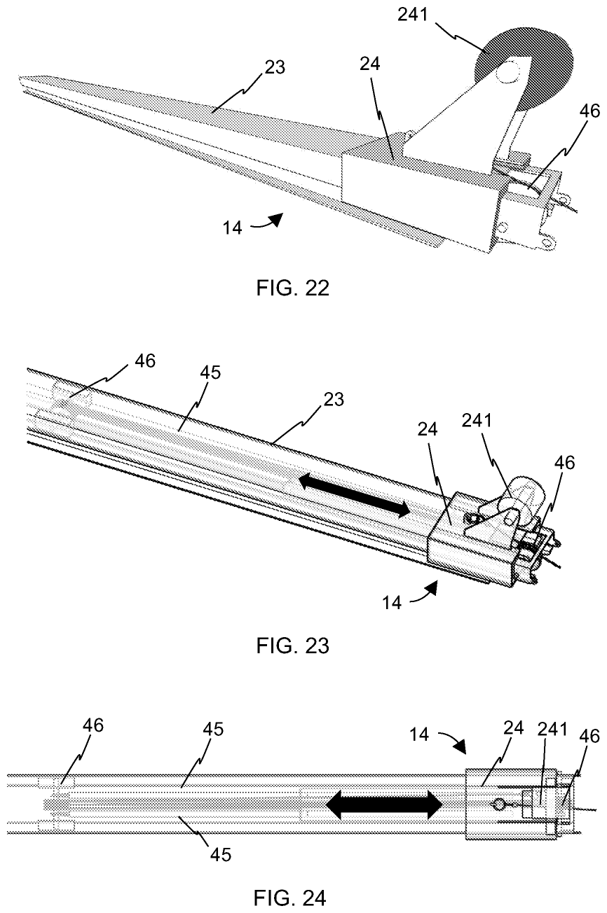

The bracket 24 may comprise an aperture for allowing a winch cable 27 of the winch 17 to pass through for connecting to a hoist attachment arrangement 33 on a container 3, and a bracket roller 241 for movably engaging the container 3. These details are illustrated in FIGS. 22 through 24.

In alternative embodiments (not shown) the pushing device 14 may comprise resilient elements configured to urge the container 3 away from the winch 17 along the frame structure 11, such as a push spring configured to exert a resilient force on correspondingly arranged push plates 24 on the bottom of the container 3. In an embodiment, such a pushing device 14 is arranged on each guide 12 for pushing back the container 3.

The trailer 1 may further comprise a tilt control device 28 arranged between the frame structure 11 and the drawbar 21, such as a gas spring, configured to dampen the tilting movement of the frame structure 11 around the pivot axis 20.

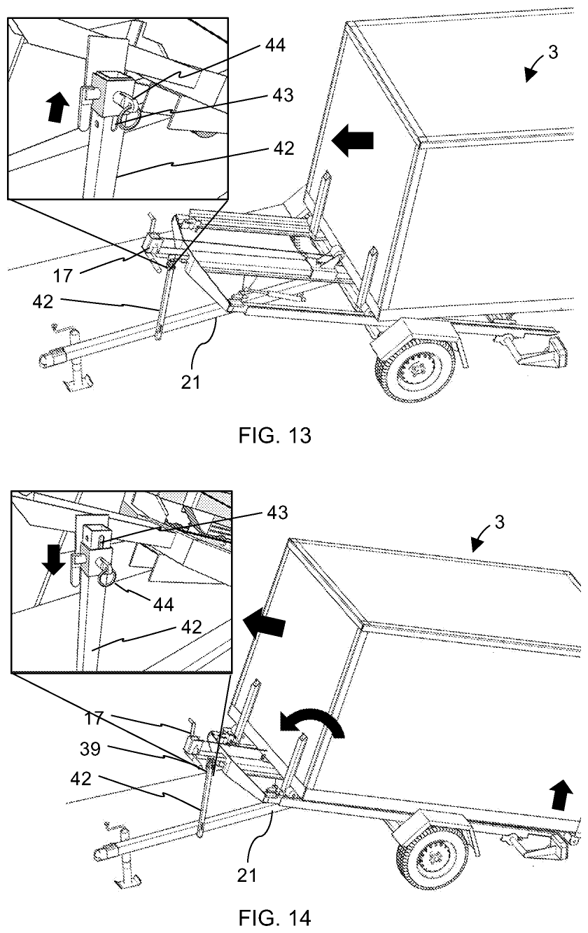

The trailer 1 may further comprise a tilt lock 42 connected to both the frame structure 11 and the drawbar 21 and configured to hold the frame structure 11 at a tilted position, as shown in more detail in FIGS. 13-14.

The frame structure 11 of the trailer 1 may further comprise a frontal locking arrangement 15 arranged at a towing end 40 of the trailer 1 to releasably hold the container 3 in a fixed position on the trailer 1, as shown in more detail in FIGS. 16-17.

With reference to FIG. 2 there is shown a top view of a trailer 1 according to an example embodiment of the invention. In this and other exemplary embodiments illustrated in the following figures, structures and features that are the same or similar to corresponding structures and features previously described or shown herein are denoted by the same reference numeral as previously used for simplicity.

As shown in this top view of the t trailer 1, the frame structure 11 comprises a crossbar 19 with a pair of wheels 16 arranged at its distal ends, the crossbar 19 being arranged perpendicular to the guides 12.

The crossbar 19 may define a wheel axis around which the frame structure 11 is arranged to tilt; wherein the pivot axis 20 may be arranged off-axis from the wheel axis towards the winch 17.

A middle bar 23 is further arranged between and parallel to the guides 12, the middle bar 23 being pivotally connected to the drawbar 21 and non-pivotally connected to the crossbar 19 and extending to the loading end 41 of the trailer 1.

The bracket 24 may be arranged on the middle bar 23 to be slidable along the middle bar 23 for pushing the container 3 away from the winch 17, as shown in more detail in FIGS. 22-24, wherein the bracket 24 can be connected to the middle bar 23 through resilient elements 45 configured to urge the bracket 24 away from the winch 17 until a position at the distal end of said middle bar 23.

The frame structure 11 may further comprise a handle 39 that is arranged on the middle bar 23 to manually engage and tilt the frame structure 11 with respect to the drawbar 21.

The middle bar 23 may further comprise a rotatable end element 231 arranged at the loading end 41 for supporting a license plate, wherein the rotatable end element 231 is configured for automatically rotating when engaging with the ground, as illustrated in FIG. 21.

As also shown in FIG. 2, the elongated guides 12 may comprise rotatable side elements 121 for supporting brake lights of the trailer 1. The rotatable side elements 121 can be configured for automatically rotating around a side element axis 122 when the frame structure 11 engages with the ground so that the brake lights don't interfere with the loading of the container 3 on the trailer 1, as illustrated in more detail in FIG. 20.

The frame structure 11 of the trailer 1 may further comprise end rollers 18 arranged adjacently to the elongated guides 12 to engage with the ground when the frame structure 11 is tilted and to provide an engagement and guiding surface for guide rails 31 arranged on the bottom of a container 3 for facilitating loading the container 3 on the frame structure 11, as shown in more detail in FIGS. 8-9.

With reference to FIG. 3 there is shown an isometric view of a trailer 1 according to an example of the invention, wherein structures and features that are the same or similar to corresponding structures and features previously described are denoted by the same reference numeral as previously used for simplicity.

As shown in this perspective, the guides 12 comprise elongated channels 13 for slidably guiding rollers or rails of a container 3 along the frame structure 11, and each guide 12 further comprises a frontal locking arrangement 15 arranged at its towing end 40 to releasably hold the container 3 in a fixed position on the trailer 1.

FIGS. 4 through 12 illustrate consecutive steps of loading a container 3 on a trailer 1 as described before.

With reference to FIG. 4 there is shown a side view of a trailer 1 and a container 3 according to an example of the invention arranged adjacently in a state before loading the container 3 on the trailer 1.

The container 3 comprises a bottom 37 and side walls 38 together defining an at least partially enclosed space for accommodating cargo. The container 3 can be a fully enclosed box or an upwardly open box. Alternatively, other kinds of containers could be used instead of the box illustrated in the figures, for instance swap boxes.

The container 3 further comprises at least two substantially parallel elongated horizontal guide rails 31 arranged on the bottom 37 to correspond to the aforementioned elongated guides 12 of the trailer 1 for guiding linear movement of the container 3 along a frame structure 11 of the trailer 1 when pulled by a winch 17 or when pushed by a pushing device 14.

The container 3 further comprises at least one container back roller 32 arranged on the bottom 37 at a distal end of the container 3 for engagement between the container 3 and the ground and facilitating linear movement of the container 3 on the ground.

The container 3 further comprises at least one container front roller 30 arranged on an opposite distal end of the container 3 from the at least one container back roller 32. Each container front roller 30 is arranged in a lifted position off the ground when the container 3 is resting on the ground.

As shown in FIG. 5, the container 3 may also comprise a hoist attachment arrangement 33 for attaching a winch cable 27 of a winch 17 as mentioned before.

The maximum width of the container and/or the distance between the guide rails 31 and the container front rollers 30 is determined by the distance between the wheels 16 of the trailer, which in turn determine the distance between the parallel guides 12.

In this initial position the container 3 is not yet loaded on the trailer 1 just positioned adjacent to it so that the container guide rails 31 are aligned parallel with the trailer guides 12.

The trailer 1 is shown in a tilted position already, which is a result of tilting the frame structure 11 around the pivot axis 20 from a horizontal position to a tilted position (e.g. using the handle 39) after arranging the trailer 1 at adjacent to the container 3 and detaching the trailer from its towing vehicle (not shown) so that the drawbar 21 rests on the jack stand 22. This is followed by fixing the frame structure 11 in a tilted position using e.g. the aforementioned tilt lock 42 connected to both the frame structure 11 and the drawbar 21. In this tilted position each elongated guide 12 is positioned adjacent to and aligned with a corresponding front roller 30 and/or guide rail 31 of the container 3.

In a next step of the method of loading the container 3 onto the trailer 1, the trailer 1 is moved closer to the container 3 (or vice versa) so that the end of each guide 12 is resting on the ground via end rollers 18 (as shown in FIG. 8 in more detail) and protruding below the corresponding (lifted) container front roller 30 the container 3 so that the front rollers 30 can engage the guides 12, and the contact surface 34 of each guide rail 31 of the container 3 can also engage the end rollers 18 of the frame structure 11 that further facilitate sliding the container 3 on the trailer 1.

In a next step the winch cable 27 of the winch 17 of the trailer 1 is secured to the hoist attachment arrangement 33 arranged on the container 3 and the winch drum 26 of the winch 17 is activated (e.g. by manual turning of a handle) to actuate moving the container 3 in a first direction onto the frame structure 11 while further engaging the front rollers 30 and/or the guide rails 31 with the guides 12 of the trailer 1.

In this state the container 3 is moved using the winch 17 from a first position where the container is still partially resting on the ground and where the frame structure 11 is also still engaged with the ground at its loading end 41 into a next position shown below in FIG. 11 where the trailer 1 is still at least partially resting on the ground through the end rollers 18 of the guides 12 but the container 3 is no longer engaged with the ground.

With reference to FIG. 5 there is shown a side view of a trailer 1 and a container 3 according to an example of the invention in such an intermittent state during loading the container 3 on the trailer 1 as described before. As illustrated, in this intermittent position both the back rollers 32 of the container 3 and the end rollers 18 of the trailer guides 12 engage with the ground.

With reference to FIG. 6 there is shown an isometric view of a trailer 1 and a container 3 in the same intermittent state during loading the container 3 on the trailer 1, with a zoomed-in view of the details of the guide rails 31 and frontal reinforcements 36 of the container 3.

As shown in FIG. 6, the container 3 comprises at least one pair of container front rollers 30 arranged adjacent to the guide rails 31 on an outer side thereof towards respective edges of the container bottom 37 to correspond to the pair of elongated guides 12 of the trailer 1 for guiding linear movement of the container 3 along a frame structure 11 of the trailer 1 when pulled by a winch 17 or when pushed by a pushing device 14, while ensuring that the center of gravity of the container 3 stays aligned with the center of the trailer 1.

As further illustrated, the two elongated guide rails 31 of the container 3 are arranged correspondingly to the two elongated guides 12 of the frame structure 11 of the trailer 1 for guiding linear movement of the container 3 along the frame structure 11 when pulled by the winch 17 and when pushed by the pushing device 14.

As shown in the zoomed-in view of FIG. 6, the container 3 further comprises at least two frontal reinforcements 36 on the frontal side wall 38 facing the trailer 1, the frontal reinforcements 36 being arranged as a vertical continuation f the horizontal guide rails 31 and configured to provide additional structural support for the container 3.

In the illustrated example the frontal reinforcements 36 are arranged on a same side wall 38 as the at least two container front rollers 30, the container front rollers 30 being arranged adjacent to the frontal reinforcements 36 in a permanently lifted-up position off the ground, i.e. with respect to the bottom of the guide rails 31 of the container 3. In alternative embodiments the front rollers 30 can be arranged to be vertically movable, so that they can provide rolling function on the ground but can also be lifted up when the container 3 is loaded onto a trailer 1. The frontal reinforcements 36 may comprise engaging elements for engagement with corresponding frontal locking arrangement 15 of the trailer 1 to releasably hold the container 3 in a fixed position on the trailer 1, such as frontal locking holes 361 each arranged to receive an elongated protruding element 151 of a corresponding frontal locking arrangement 15 of the trailer 1, as further illustrated in FIG. 16. Alternatively, the frontal locking arrangement 15 may comprise a safety mechanism, such as a latch, that locks automatically when engaging with the corresponding engaging elements of the container 3 and disengages manually or automatically when the container 3 is pushed away from the trailer 1. This mechanism enhances safety in case the operator would forget locking the container on the trailer.

As further shown in the zoomed-in view of FIG. 6, each of the guide rails 31 may further comprise a non-vertical contact surface 34 arranged on its distal loading end for facilitating loading of the container 3 on the trailer 1. The contact surface 34 may be inclined at a contact angle, preferably being between 30 to 60 degrees, more preferably 45 degrees with respect to the vertical angle.

In another embodiment (not shown) the contact surface 34 may comprise a stepped inclination at different consecutive angles. In another embodiment (also not shown) the contact surface 34 may be a curved surface.

With reference to FIG. 7 there is shown a partial zoomed-in isometric view of the trailer 1 and the container 3 still arranged in a state during loading as described before. As illustrated, the bracket roller 241 of the bracket 24 engages the front wall of the container 3 in a way that allows vertical movement of the container 3 with respect to the bracket 24 but still provides sufficient support through engagement and through being constantly pushed towards the container 3 by resilient elements 45. As also illustrated, the front rollers 30 of the container are rolling along the channels 13 of each guide 12 towards the frontal locking arrangements 15 as the winch cable 27 pulls the container 3 along the frame structure 11.

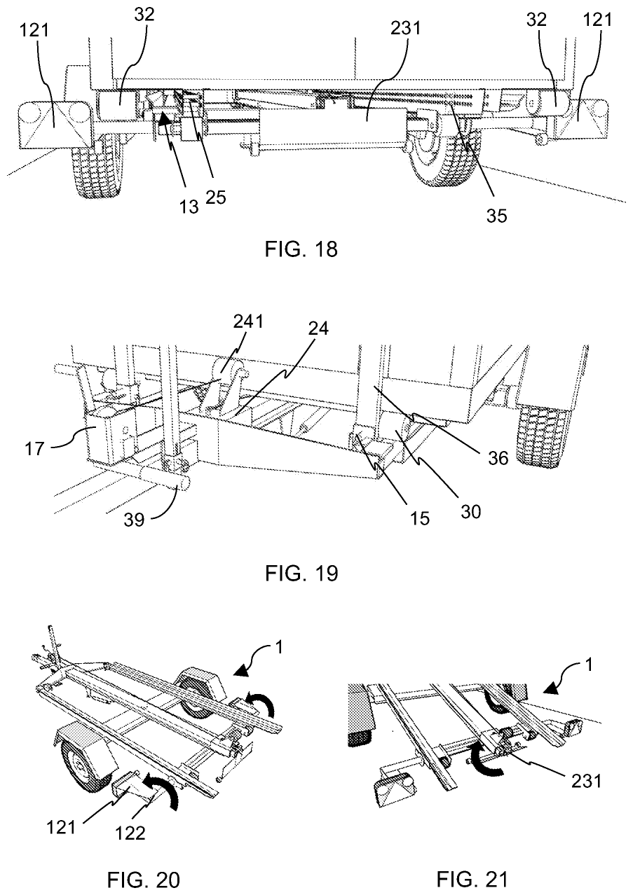

With reference to FIG. 8 there is shown a partial zoomed-in side view of a trailer 1 and a container 3 according to an example of the invention in the same state as described above, during loading the container 3 on the trailer 1. The frame structure 11 as shown comprise end rollers 18 arranged adjacently to the elongated guides 12 to engage with the ground when the frame structure 11 is tilted and to provide an engagement and guiding surface for the contact surfaces 34 of the guide rails 31 arranged on the bottom of a container 3 for taking over the bearing of the container 3 when the container back rollers 32 arranged on the bottom 37 of the container leave the ground. In the illustrated example, the elongated guide rails 31 also comprise lateral engagement holes 35 configured to engage with a lateral locking arrangement 25 of a trailer 1 as described in more detail in connection with FIG. 18.

With reference to FIG. 9 there is shown a partial zoomed-in angled back view of a trailer 1 and a container 3 according to an example of the invention in a state as described above, during loading the container 3 on the trailer 1.

In the illustrated example the container back rollers 32 are shown arranged on the bottom 37 of the container and engaging the ground, while the rotatable end element 231 arranged at the loading end 41 of the trailer 1 for supporting a license plate as described before, is shown automatically rotated so that it does not break when engaging with the ground, a function that can be facilitated by rollers for movably engaging the ground. The end of the trailer 1 is further shown with rotatable side elements 121 for supporting brake lights of the trailer 1, which can also rotate as described below in connection with FIG. 20.

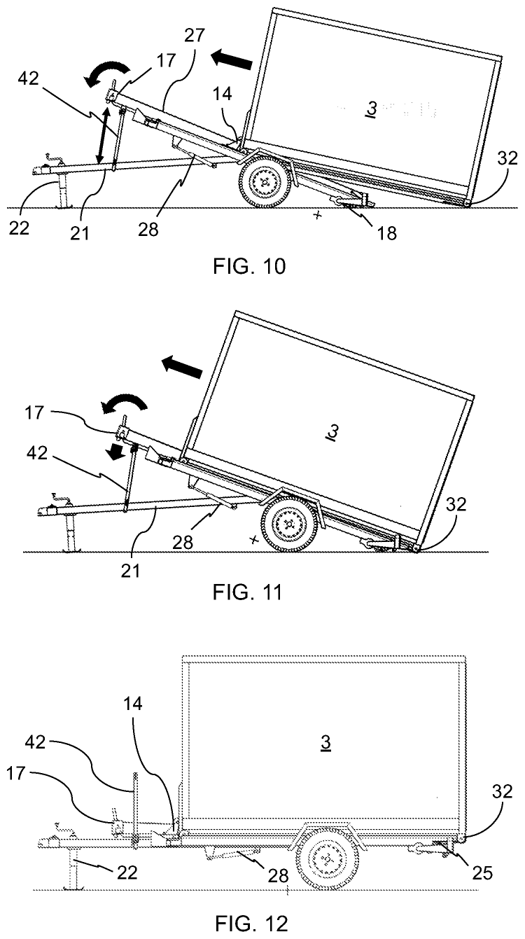

With reference to FIGS. 10 through 12 there is shown a trailer 1 and a container 3 according to an example of the invention as described before, in further consecutive states during loading the container 3 on the trailer 1. In this state the container 3 is further moved using the winch 17 from a position where the container is still partially resting on the ground and where the frame structure 11 is also still engaged with the ground at its loading end 41 as shown in FIG. 10, through a next position shown in FIG. 11 where the trailer 1 is still resting on the ground through the end rollers 18 of the guides 12 but the container 3 is no longer engaged with the ground at the back rollers 32, into a final position shown in FIG. 12 where the container 3 is fully supported by the trailer 1 and the frame structure 11 is tilted back to a horizontal position after unlocking the tilt lock 42 and allowing the frame structure to pivot around the pivot axis 20.

The transition between these states is further illustrated in detail in FIGS. 13 and 14 with zoomed-in view of the different states of the tilt lock mechanism 42.

In particular, the tilt lock 42 as described before is connected to both the frame structure 11 and the drawbar 21 and configured to hold the frame structure 11 at a tilted position by keeping a minimum distance between its two contact points to the frame structure 11 and the drawbar 21 respectively.

As shown in the zoomed-in views the tilt lock 42 comprises an elongated tilt lock slot 43, and the tilt lock 42 itself is configured to be connected to the frame structure 11 via a tilt lock pin 44 arranged to slidably move in said tilt lock slot 43 to allow limited tilting movement of the frame structure 11 while still keeping a minimum distance from the drawbar 21.

As shown in FIG. 13, for a while as the container 3 is being pulled on the trailer 1 from an initial unsupported position the tilt lock pin 44 (and/or an optional sliding bracket of the tilt lock pin 44) will be abutting the upper end of the tilt lock slot 43 indicating that the weight center of the container 3 is still behind the pivot axis 20 of the trailer 1 and thus urges the towing end 40 of the frame structure 11 upwards with respect to the drawbar 21. However, as shown in FIG. 14, once the the weight center of the container 3 passes the pivot axis 20 of the trailer 1 it will start to urge the towing end 40 of the frame structure 11 downwards with respect to the drawbar 21, which is indicated by the tilt lock pin 44 (and/or an optional sliding bracket of the tilt lock pin 44) abutting the lower end of the tilt lock slot 43.

This mechanism allows the operator of the trailer 1 to easily assess visually (and also audibly) at all times where the weight center of the container 3 is with respect to the trailer 1 which helps indicating at which point it is easiest to tilt the frame structure 11 around the pivot axis 20 using e.g. a handle 39 supported on the frame structure 11.

Once the frame structure 11 is tilted to a horizontal position after unlocking the tilt lock 42 and allowing the frame structure to pivot around the pivot axis 20, the container 3 is moved to a final transport position on the trailer 1 as shown in FIG. 12, which is realized by locking the winch drum 26 and securing the container 3 on the frame structure 11 using the aforementioned combination of a frontal locking arrangement 15 and a lateral locking arrangement 25.

The unloading of the container 3 from the trailer 1 is executed in a reversed sequence as illustrated from FIG. 12 where the the container 3 is in a transport position on the trailer 1 to FIG. 4 where the container 3 is fully offloaded from the trailer 1 and positioned adjacent to it.

In particular, before the unloading starts, the trailer 1 is moved to the destination where the container 3 needs to be located and the trailer 1 is optionally unhooked from its towing vehicle—however this step is optional, and the trailer 1 can be kept hooked to the towing vehicle for the offloading.

If it's not already secured, the winch cable 27 of the winch 17 of the trailer 1 is then secured at one end to the hoist attachment arrangement 33 on the container 3 and the winch drum 26 of the winch 17 is unlocked to controllably allow linear movement of the container 3 along the frame structure 11.

To initiate this linear movement of the container 3, the pushing device 14 shown in detail in FIGS. 22-24 is activated to exert a force on the container 3 through its bracket 24 and bracket roller 241 and push the container 3 along the guides 12 away from the winch 17.

Once the container 3 passes the pivot axis 20 with its weight center the frame structure 11 of the trailer 1 can be tilted around the pivot axis 20 from a horizontal h position to a tilted position and fixed in the tilted position using e.g. the aforementioned tilt lock 42 that is connected to both the frame structure 11 and the drawbar 21.

Then the container 3 is kept controllably moving along the guides 12 away from the winch 17 using the pushing force of the pushing device 14 and the winch drum 26 until the back rollers 32 of the container 3 engage with the ground as shown in FIG. 11.

In this position the drawbar 21 can be pulled in a direction away from the container 3 while allowing the container 3 to move entirely off from the frame structure 11 as shown in FIG. 4.

The tilt lock 42 can then be unlocked to allow the frame structure 11 to be moved from the tilted position back to the horizontal position (e.g. using the handle 39) on the trailer 1 as shown in FIGS. 1-3.

With reference to FIG. 15 there is shown a cross-section of the longitudinal beam of a guide 12 of the trailer 1 according to an example of the invention. As illustrated, the elongated channels 13 arranged in each guide 12 may have a substantially L-shaped cross-section with a horizontal support wall 131 and a vertical guide wall 132 for restricting lateral movement of corresponding parts of the container 3 in an direction outward from the center of the trailer 1, such as the guide rails 31 and/or container front rollers 30.

As further illustrated, the elongated channels 13 may also comprise an upwardly and outwardly slanted guide wing 133 for guiding the guide rails 31 and/or container front rollers 30 of the container 1 into the channels 13.

The width of the horizontal support wall may largely correspond to the height of the vertical guide wall 132. As illustrated, the width of the horizontal support wall 131 in an embodiment is 83 mm, while the height of the vertical guide wall 132 together with the guide wing 133 amounts to 91 mm.

The elongated channels 13 may also comprise an elongated channel rail 134 arranged therein for providing vertical support for the weight of the container 1 and for restricting upward movement of the container 1 via an elongated lateral channel rail recess 135 arranged therein. This channel rail 134 may thus serve for the purpose of movably and lockably arranging further functional parts of the trailer thereon, such as the frontal locking arrangements 15 shown in FIGS. 16 and 17.

With reference to FIG. 16 there is shown a partial zoomed-in top view of a trailer 1 and a container 3 according to an example of the invention when the container 3 is loaded on the trailer 1 in an almost final transport position.

In this illustrated example each guide 12 comprises a frontal locking arrangement 15 arranged on their distal end towards the winch 17 (i.e. at the towing end 40 of the trailer 1) to releasably hold the container 3 in a fixed position on the trailer 1.

The frontal locking arrangement is configured for allowing the container 3 to slide in a direction away from the winch 17.

As shown in FIG. 16, each frontal locking arrangement 15 is configured to engage correspondingly arranged frontal reinforcements 36 on a side wall 38 of a container 3. In particular, in these illustrated examples each frontal locking arrangement 15 comprises an elongated protruding element 151 configured to be received in a correspondingly sized frontal locking hole 361 arranged in each frontal reinforcement 36.

In the illustrated embodiment each frontal locking arrangement 15 further comprises a stop bracket 152 configured for restricting movement of the trailer 1 in a direction towards the winch 17.

Although the scope of the invention is not limited to any specific numerical values for the various dimensions described above, typical values/ranges of the dimensions shown in FIG. 16 for the distance Dg between the guides 12 of the trailer (more specifically distance between the vertical guide walls 132 of the guides 12) is Dg=1166 mm, the distance Dr between the guide rails 31 of the container (more specifically distance between the outer walls of the guide rails 31, which is the same as the distance between the outer walls of the frontal reinforcements 36) is Dr=1000 mm, while the distance between the wheels 16 of the trailer can vary up to 2500 mm.

With reference to FIG. 17 there is shown a partial zoomed-in perspective view of the frontal locking arrangement 15 of the trailer 1 as described before. As illustrated, the frontal locking arrangement 15 is arranged to be slidable along the elongated guide 12 and lockable in various positions along the length of the guide 12, using e.g. a removable locking pin 153 configured to engage correspondingly sized holes in each elongated guide 12.

With reference to FIG. 18 there is shown a partial zoomed-in perspective view of the back of trailer 1 and a container 3 according to an example of the invention arranged in a transport state.

As illustrated, at least one of the guides 12 comprises a lateral locking arrangement 25 configured to releasably hold the container 3 in a fixed position on the frame structure 11, the lateral locking arrangement 25 being positioned on the at least one guide 12 at its loading end 41.

In the illustrated example the lateral locking arrangement 25 is a removable part that can be inserted at various locations along the guide rails 31 of the container 3 using a manual handle and comprises protruding pins configured to engage with correspondingly arranged lateral engagement holes 35 on the container 3.

Advantageously, and depending on the length of the container 3 to be arranged on the trailer 1, each guide 12 may comprise a frontal locking arrangement 15 arranged at the towing end 40, and a lateral locking arrangement 25 arranged at the loading end 41, wherein the frontal locking arrangement only limits movement towards the winch 17 and in directions perpendicular to the elongated guides 12, i.e. to each side and upwards or downwards, while still allowing the container 3 to slide along the guides 12 away from the winch 17. This backward sliding movement is limited on the other hand by the aforementioned lateral locking arrangements 25 at the back of the guides 12, thereby providing an adjustable and robust solution for fixing the container 3 on the trailer 1.

With reference to FIG. 19 there is shown a partial zoomed-in perspective view of the front of trailer 1 and a container 3 according to an example of the invention arranged in a transport state and fixed using the frontal locking arrangements 15 and the lateral locking arrangements 25 as described before. As shown, in this state the bracket 24 engages the front wall of the container 3 through the bracket roller 241 and the front rollers 30 are resting on the guides 12 in their corresponding channels 13.

With reference to FIGS. 20 and 21 there is shown perspective views of rotatable end element 231 and side elements 121 arranged on the back of a trailer 1 according to further examples of the invention.

In the example shown in FIG. 20 the elongated guides 12 comprise rotatable side elements 121 for supporting brake lights of the trailer 1. The rotatable side elements 121 are configured for automatically rotating around a side element axis 122 when the frame structure 11 engages with the ground so that the brake lights don't interfere with the loading of the container 3 on the trailer 1.

In the example shown in FIG. 21 the middle bar 23 comprises a rotatable end element 231 arranged at the loading end 41 for supporting a license plate and being configured for automatically rotating when engaging with the ground, such as through rollers for movably engaging the ground as also shown in FIGS. 8 and 9.

With reference to FIGS. 22 through 24 there is shown different views of a pushing device 14 arranged on the trailer 1 according to an example of the invention.

The pushing device 14 in these shown embodiments is in the form of a bracket 24 arranged slidably on the frame structure 11 1 and configured to engage and push the container 3 away from the winch 17 along the frame structure 11. The bracket 24 comprises an aperture for allowing a winch cable 27 of the winch 17 to pass through for connecting to a hoist attachment arrangement 33 on a container 3, and a bracket roller 241 for movably engaging the container 3.

The bracket 24 is connected to the middle bar 23 through resilient elements 45 configured to urge the bracket 24 away from the winch 17 until a position at the distal end of said middle bar 23.

The resilient elements 45 may be a gas spring configured to exert a resilient force on the bracket 24 via a dampened extending and retracting motion.

As shown in FIGS. 23 and 24, the resilient elements 45 can be arranged within the the middle bar 23 and configured to urge said bracket 24 away from the winch 17. In examples such as the one illustrated, the bracket 24 is connected to the at least one resilient element 45 via a pulley system 46.

The fact that according to the invention it is possible to support and attach containers 3 of a length and height within a broad range and if desired of a much smaller length than the length of the guides 12 of the trailer makes the invention extremely useful for easy loading/reloading and transport of many different types and dimensions of containers 3. This ease of application is further increased by the provision of the quick lock mechanisms as explained before, such as the frontal locking arrangements 15 which can be slidably positioned along each guide 12 of the frame structure 11 to allow fixing in place even multiple containers 3 on one trailer 1, further making use of the lateral locking arrangements 25 of the trailer 1 that can be arranged at the back of each container 3 and fixed using corresponding lateral engagement holes 35 of the guide rails 31 of the container 2.

The figures are a schematic representation of an example use of containers 3 and trailers 1 according to the invention, which can be applied in an exemplary situation where goods have been delivered to a transit area, for instance on large trucks or on railway wagons (not shown in the figures) and stored in containers 3 according to the invention. Containers 3 can then be loaded on the trailers 1 as shown in the application figures. An automobile may then pick up a trailer 1 with a container 3 and leave the transit area. Distribution of the goods in the containers 3 according to the invention can finally take place by means of environmental friendly vehicles. The flexible and versatile containers 3 and trailers 1 according to the invention make it easy and economically attractive to re-load goods from less environmental friendly and possibly larger vehicles to more environmental friendly and possibly smaller vehicles, that can furthermore be more easy to maneuver within an inner region of a city with narrow streets and much traffic.

Although the teaching of this application has been described in detail for purpose of illustration, it is understood that such detail is solely for that purpose, and variations can be made therein by those skilled in the art without departing from the scope of the teaching of this application.

The term “comprising” as used in the claims does not exclude other elements or steps. The term “a” or “an” as used in the claims does not exclude a plurality.

1. A single or dual axle trailer for transporting a container, the trailer comprising:
a towing end and an oppositely arranged loading end;
a drawbar arranged at the towing end and configured to be attached to a towing vehicle; and
a frame structure pivotally connected to the drawbar for selectively allowing the frame structure to pivot about a pivot axis parallel with the single or dual axle;
the frame structure comprising:
at least two substantially parallel elongated guides for guiding linear movement of the container along the frame structure;
a winch for pulling the container from the loading end in a direction towards the winch; and
a pushing device configured to push the container in a direction away from the winch,
wherein the pushing device comprises a bracket arranged slidably on the frame structure and at least one resilient element configured to urge the bracket away from the winch.

2. A trailer according to claim 1, wherein the frame structure comprises:
a middle bar arranged between and parallel to the guides, the middle bar being pivotally connected to the drawbar and extending to the loading end of the trailer, wherein the bracket is arranged on the middle bar and connected to the middle bar through the at least one resilient element that is configured to urge the bracket away from the winch until a position at a distal end of the middle bar.

3. A trailer according to claim 1, further comprising a tilt lock connected to both the frame structure and the drawbar and configured to hold the frame structure at a tilted position by keeping a minimum distance between its two contact points to the frame structure and the drawbar respectively;
wherein the tilt lock comprises an elongated tilt lock slot for connecting to the frame structure and configured to allow limited tilting movement of the frame structure while still keeping a minimum distance from the drawbar.

4. A trailer according to claim 1, wherein the frame structure further comprises a frontal locking arrangement arranged at a towing end of the trailer to releasably hold the container in a fixed position on the trailer, wherein the frontal locking arrangement is configured for allowing the container to slide in a direction away from the winch.

5. A trailer according to claim 1, wherein at least one of the guides comprises a lateral locking arrangement configured to releasably hold the container in a fixed position on the frame structure, the lateral locking arrangement being positioned on the at least one guide at its loading end.

6. A container comprising a substantially flat rectangular bottom and side walls extending from each edge of the bottom together defining an at least partially enclosed space above the bottom for accommodating cargo; the container further comprising at least two parallel guide rails arranged under the flat bottom, the guide rails being arranged substantially parallel to a second and fourth edge of the rectangular bottom and extending from a first edge of the bottom towards a third edge of the bottom, wherein the guide rails comprise a planar bottom surface that curves or angles upwards at the first edge thereby defining a contact surface for slidably guiding the container onto a transport vehicle such as a trailer,
wherein the container further comprises container front rollers arranged at the first edge adjacent to the guide rails in a lifted position off the ground when the container is resting on the ground,
wherein each front roller is arranged on an outer side of an adjacent guide rail towards the closest of the second or fourth edge.

7. A container according to claim 6, wherein the front rollers are arranged to be vertically movable, so that they can provide rolling function on the ground but can also be lifted up when the container is loaded onto a transport vehicle and provide rolling function with corresponding elements of the transport vehicle.

8. A container according to claim 6, wherein the container further comprises at least two parallel frontal reinforcements on at least one side wall to provide additional structural support for the container, wherein the frontal reinforcements are arranged as a continuation of the guide rails.

9. A container according to claim 6, wherein the container further comprises engaging elements for engagement with corresponding frontal locking arrangement of a transport vehicle such as a trailer to releasably hold the container in a fixed position on the transport vehicle.

10. A transport system comprising:
a trailer according to claim 1; and
a container comprising a substantially flat rectangular bottom and at least one of parallel guide rails or container front rollers arranged under the bottom correspondingly to the at least two elongated guides of the trailer for guiding linear movement of the container along the frame structure when pulled by the winch or when pushed by the pushing device.

11. A transport system according to claim 10, wherein the container comprises a substantially flat rectangular bottom and side walls extending from each edge of the bottom together defining an at least partially enclosed space above the bottom for accommodating cargo; the container further comprising at least two parallel guide rails arranged under the flat bottom, the guide rails being arranged substantially parallel to a second and fourth edge of the rectangular bottom and extending from a first edge of the bottom towards a third edge of the bottom, wherein the guide rails comprise a planar bottom surface that curves or angles upwards at the first edge thereby defining a contact surface for slidably guiding the container onto a transport vehicle such as a trailer, and
container front rollers arranged at the first edge adjacent to the guide rails in a lifted position off the ground when the container is resting on the ground, wherein each front roller is arranged on an outer side of an adjacent guide rail towards the closest of the second or fourth edge.

12. A method of handling a container comprising the steps of:
providing a trailer according to claim 1;
providing container comprising a substantially flat rectangular bottom and at least one of parallel guide rails or container front rollers arranged under the bottom correspondingly to the at least two elongated guides of the trailer;
pulling the container in a first direction onto the frame structure using the winch while engaging at least one of the guide rails or the container front rollers with the elongated guides; and
securing the container on the frame structure using at least one releasable locking arrangement.

13. The method according to claim 12, wherein the method further comprises the steps of:
before pulling the container onto the frame structure, tilting the frame structure around a pivot axis from a horizontal position to a tilted position;
fixing the frame structure in a tilted position using a tilt lock connected to both the frame structure and the drawbar;
moving the container from a first position where the container is at least partially resting on the ground and where the frame structure is engaged with the ground into a second position where the frame structure is still at least partially resting on the ground but the container is no longer engaged with the ground;
unlocking the tilt lock and tilting the frame structure around the pivot axis from the tilted position to the horizontal position; and
further moving the container into a third position where the container can be secured on the trailer.

14. A method of handling a container comprising the steps of:
providing a trailer according to claim 1;
providing a container on the trailer, the container comprising a substantially flat rectangular bottom, side walls, and at least one of parallel guide rails or container front rollers arranged under the bottom arranged on corresponding elongated guides of the trailer, the winch being connected to the container and the pushing device engaging one of the side walls;
activating the at least one resilient element of the pushing device to urge the bracket away from the winch and thereby exert a force on the container and push the container away from the winch in a second direction;
moving the container along the guides using the pulling force of the winch and the pushing force of the pushing device until at least a portion of the container engages with the ground in a tilted position of the frame structure; and
moving either the trailer or the container relative to each other until the container is entirely off from the frame structure.

15. The method according to claim 14, wherein the method further comprises the steps of:
before the container engages with the ground, tilting the frame structure around a pivot axis from a horizontal position to a tilted position;
fixing the frame structure in the tilted position using a tilt lock connected to both the frame structure and the drawbar; and
after the container is entirely off from the frame structure, unlocking the tilt lock to allow the frame structure to move from the tilted position back to the horizontal position.

16. The method according to claim 12, wherein the container comprises a substantially flat rectangular bottom and side walls extending from each edge of the bottom together defining an at least partially enclosed space above the bottom for accommodating cargo; the container further comprising at least two parallel guide rails arranged under the flat bottom, the guide rails being arranged substantially parallel to a second and fourth edge of the rectangular bottom and extending from a first edge of the bottom towards a third edge of the bottom, wherein the guide rails comprise a planar bottom surface that curves or angles upwards at the first edge thereby defining a contact surface for slidably guiding the container onto a transport vehicle such as a trailer, and
container front rollers arranged at the first edge adjacent to the guide rails in a lifted position off the ground when the container is resting on the ground,
wherein each front roller is arranged on an outer side of an adjacent guide rail towards the closest of the second or fourth edge.
